(19) United States
(12) Patent Application Publication
(10) Pub. No.: US 2008/0298781 A1
(43) Pub. Date: Dec. 4, 2008

(54) APPARATUS FOR RECORDING AUDIO-VIDEO DATA AND METHOD OF RECORDING AUDIO-VIDEO DATA

(75) Inventor: Masahide Yanagihara, Inagi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/128,555

(22) Filed: May 28, 2008

(30) Foreign Application Priority Data
May 31, 2007 (JP) 2007-145803

(51) Int. Cl. H04N 5/00

(52) U.S. Cl. 386/125; 386/E05.001

(57) ABSTRACT

According to one embodiment, an apparatus for recording audio-video information includes a storage device configure to store audio-video information containing video data and audio data, an optical disc drive configured to record the audio-video information in a recoding-type optical disc, detecting section configure to detect a free space available in the recoding-type optical disc, when the audio-video information is being recorded in the recoding-type optical disc, and analysis-type divided-recording control section configure to analyze the content of the audio-video information when the detected free space is smaller than a preset value, thereby detecting dividing points, to divide the audio-video information into parts in accordance with the detected dividing points, and to control recording the parts of the audio-video information in the recoding-type optical disc and at least one other recoding-type optical disc.

### CROSS-REFERENCE TO RELATED APPLICATIONS

This application is based upon and claims the benefit of priority from Japanese Patent Application No. 2007-145803, filed May 31, 2007, the entire contents of which are incorporated herein by reference.

### BACKGROUND

1. Field

One embodiment of the invention relates to an apparatus for recording digital audio-video data in recoding-type optical discs and a method of recording digital audio-video data in such optical discs.

2. Description of the Related Art

In digital broadcasting, the high-efficiency encoding system called Moving Picture Experts Group Phase 2 (MPEG-2) is used as a system for compressing video data. To transmit video-compressed digital signals, a transport stream system is employed which achieves multiplex real-time transmission of, for example, broadcast signals. In any digital-broadcast receiver that receives a transport stream (TS), compressed video data is first extracted from the transport stream, and is then decoded into a video signal by a video encoder. The video signal thus obtained is supplied to the display. The display displays the moving picture represented by the video signal.

Transport streams can be recorded in hard disks. Apparatuses are available which have an optical disc drive, such as HD DVD drive, and can read a transport stream from a hard disk drive and record the transport stream in an HD DVD-R disc or the like.

A transport stream may be too large to be recorded in one HD DVD-R disc. In this case, parts of the transport stream, i.e., audio-video data, must be recorded in a plurality of optical discs. The publication Identified above discloses the technique of recording a transport stream in optical discs (see Jpn. Pat. Appln. KOKAI Publication No. 2005-174390).

However, the above-identified publication does not teach the positions where the transport stream is divided into parts. Then, when the optical discs are played back, the movie displayed will stop at the middle of a scene, inevitably annoying the viewers.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view schematically illustrating an apparatus for recording audio-video data, according to a first embodiment of the present invention;

FIG. 2 is an exemplary block diagram showing a system configuration the apparatus of FIG. 1 may have;

FIG. 3 is exemplary diagram depicting the configuration of a transport stream that the apparatus of FIG. 1 may record;

FIG. 4 is an exemplary flowchart explaining how the apparatus of FIG. 1 records a transport stream;

FIG. 5 is an exemplary block diagram showing the configuration provided in the apparatus according to the first embodiment and designed to record a transport stream stored in the HDD incorporated in the apparatus, in an HD DVD/DVD drive;

FIG. 6A, FIG. 6B, and FIG. 6C are exemplary diagrams illustrating a sequence of processing a transport stream;

FIG. 7 is an exemplary diagram showing a window that the control unit of the apparatus displays;

FIG. 8 is an exemplary flowchart explaining how an HD DVD/DVD drive operates to read a transport stream stored in the HDD and store the transport stream in a DVD-R disc;

FIG. 9 is an exemplary block diagram showing a configuration that first performs trans-coding on the content of a transport stream, generating audio-video data, and then stores the audio-video data in an DVD-R disc; and

FIG. 10 is an exemplary flowchart explaining how the trans-coding is performed and how the resulting audio-video data is recorded in a DVD-R disc.

### DETAILED DESCRIPTION

Various embodiments according to the invention will be described hereinafter with reference to the accompanying drawings. In general, according to one embodiment of the invention, an apparatus for recording audio-video information comprises a storage device configure to store audio-video information containing video data and audio data; an optical disc drive configured to record the audio-video information in a recoding-type optical disc; detecting section configure to detect a free space available in the recoding-type optical disc, when the audio-video information is being recorded in the recoding-type optical disc; and analysis-type divided-recording control section configure to analyze the content of the audio-video information when the detected free space is smaller than a preset value, thereby detecting dividing points, to divide the audio-video information into parts in accordance with the detected dividing points, and to control recording the parts of the audio-video information in the recoding-type optical disc and at least one other recoding-type optical disc.

### First Embodiment

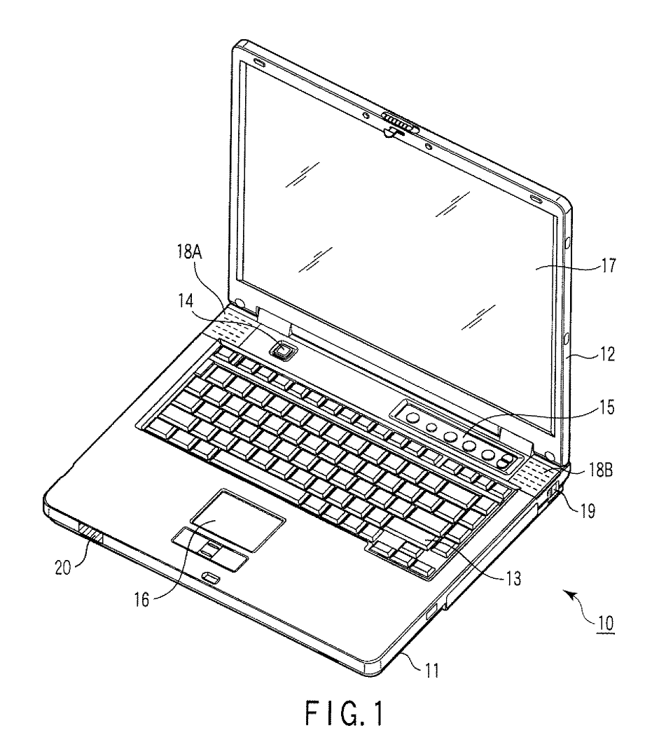

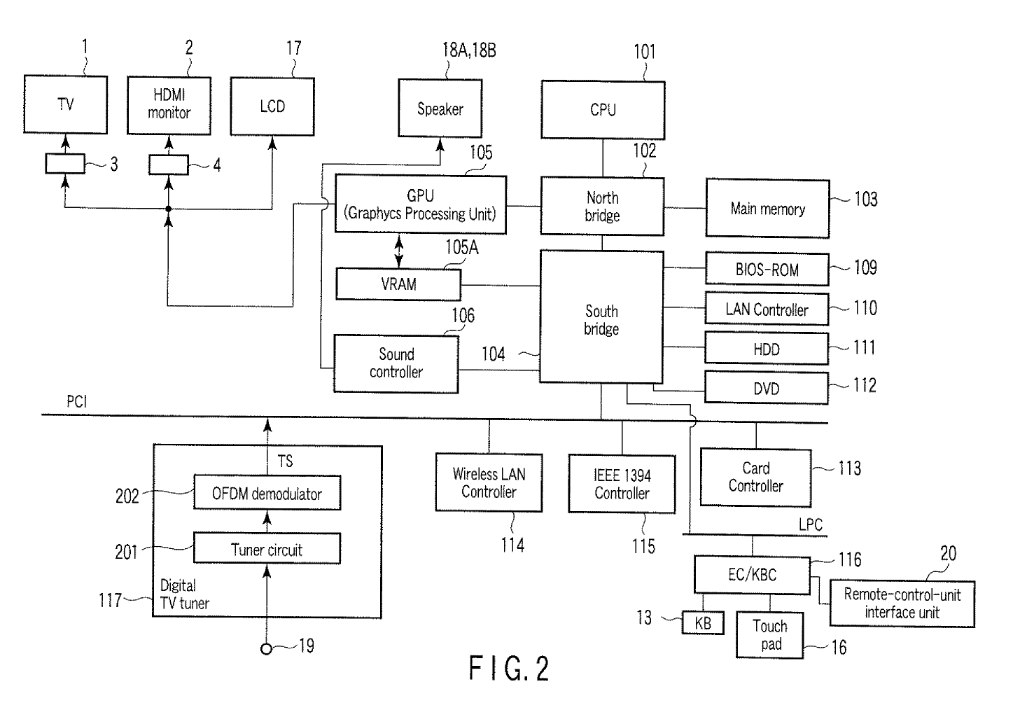

First, the configuration of an apparatus for recording audio-video data, according to a first embodiment of this invention, will be described with reference to FIGS. 1 and 2. The apparatus is implemented as, for example, a notebook-type personal computer 10.

FIG. 1 is a perspective view of the notebook-type personal computer 10, showing the display unit held in an opened position. The computer 10 comprises a main unit 11 and the display unit 12. The display unit 12 incorporates a display, which is a thin-film transistor liquid crystal display (TFT-LCD) 17. The LCD 17 has a display screen, which is located almost at the center of the display unit 12.

The display unit 12 is secured to the main unit 11 and can be rotated between the closed position and an opened position. The main unit 11 is shaped like a thin box. On the top of the main unit 11, a keyboard 13, a power button 14, an input panel 15, a touch pad 16 and speakers 18A and 18B are arranged. When a user pushes the power button 14, the computer 10 is turned on.

The input panel 15 is an input device having various buttons. The buttons may be depressed to input the events allocated to them. These buttons include some operation keys, which may be pushed to control the TV functions of the computer 10.

On the front of the main unit 11 of the computer 10, a remote-control-unit interface unit 20 is provided. The interface unit 20 is designed to perform communication with a remote-control unit that controls the TV functions of the computer 10. The interface unit 20 is constituted by, for example, an infrared-signal receiving unit.

The computer 10 can receive and playback digital-broadcast program data such as terrestrial digital-broadcast programs. On the right side of the main unit 11, an antenna terminal 19 is provided to receive terrestrial digital-broadcast programs.

The system configuration of the computer 10 will be described, with reference to FIG. 2.

As FIG. 2 shows, the computer 10 comprises a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, an HD DVD/DVD drive 112, a card controller 113, a wireless LAN controller 114, an IEEE 1394 controller 115, an embedded controller/keyboard controller (EC/KBC) IC 116, and a digital TV tuner 117.

The CPU 101 is a processor that controls the other components of the computer 10. The CPU 101 executes the operating system and various application programs that have been loaded from the hard disk drive (HDD) 111 to the main memory 103. The CPU 101 also executes the basic input output system (BIOS) that is stored in the BIOS-ROM 109. The BIOS is a hardware-controlling program.

The north bridge 102 is a bridge device that connects the local bus for the CPU 101 and the south bridge 104. The north bridge 102 incorporates a memory controller that controls the access to the main memory 103. The north bridge 102 has a function of performing communication with the GPU 105 via a serial bus of the PCT EXPRESS standards.

The GPU 105 is a display controller that controls the LCD 17 used as a display monitor for the computer 10. The GPU 105 generates a display signal, which is supplied to the LCD 17. The display signal can be supplied to an external TV 1 via an interface 3 and also to an external HDMI monitor 2 via an interface 4. Note that the interfaces 3 and 4 are provided in the main unit 11 of the computer 10.

The south bridge 104 controls all devices provided on a low-pin count (LPC) bus and all devices provided on a peripheral-component interconnect (PCI) bus. The south bridge 104 incorporates an integrated drive electronics (IDE) controller configured to control the HDD 111 and HD DVD/DVD drive 112. Further, the south bridge 104 has a function of performing communication with the sound controller 106.

The sound controller 106 is a sound-source device. It outputs audio data to the speakers 18A and 18B so that the audio data may be played back.

The card controller 113 controls cards such as PC cards and secure digital (SD) cards. The wireless LAN controller 114 is a radio communications device that performs radio communication of, for example, the IEEE 802.11 standards. The IEEE 1394 controller 115 performs communication with an external apparatus through a serial bus of the IEEE 1394 standards. The embedded controller/keyboard controller (EC/KBC) IC 116 is a one-chip microcomputer that controls an embedded controller for controlling the power, the keyboard (KB) 13 and the touch pad 16. The embedded controller/keyboard controller (EC/KBC) IC 116 has a function of turning on and off the computer 10 as the user operates the power button 14. Further, the embedded controller/keyboard controller (EC/KBC) IC 116 has a function of performing communication with the remote-control-unit interface unit 20.

The digital TV tuner 117 is a receiver that receives digital-broadcast programs such as terrestrial-digital TV broadcast programs. The TV tuner 117 is connected to the antenna terminal 19. The digital TV tuner 117 comprises a tuner circuit 201 and an orthogonal-frequency-division multiplexing (OFDM) demodulator 202. The tuner circuit 201 receives a specific-channel broadcast signal selected from the TV broadcast signals input from the antenna terminal 19.

The OFDM demodulator 202 demodulates the specific-channel broadcast signal the tuner circuit 201 has received, and extracts a transport stream (TS) from the broadcast signal thus demodulated. The transport stream is a data stream that is multiplexed data generated by multiplexing the compressed and encoded broadcast program. Any transport stream (TS) that pertains to terrestrial-digital TV broadcasting includes moving-picture data compressed and encoded, audio data compressed and encoded, and graphics data. The graphics data has been compressed and encoded, too. The graphics data includes subtitle data, still-picture data, and character-figure data. The still-picture data and the character-figure data are included in the broadcast program of each channel and present a weather-forecast, a news program, and the like.

In the field of terrestrial-digital TV broadcasting, subtitle data is called caption data, still-picture data is called pictures, and character-figure data is called figures. To the graphics data, script information is added. The script information describes the procedure of representing the graphics data. The script information is in turn described in a script language known as broadcast markup language (BML). The script information designates when and where each component of the graphics data should be displayed.

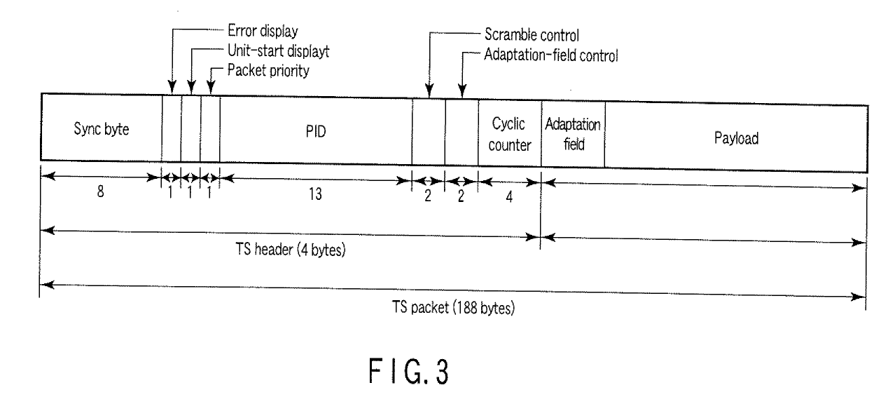

The transport stream will be described in detail. The transport stream is a signal train that consists of TS packets, each having a fixed length of 188 bytes as shown in FIG. 3. Each TS packet has a packet header, which functions as a parcel tag. The packet header contains a packet identifier (PID). Any video stream or any audio stream is transmitted in the form of a TS packet having a PID number allocated to the TS packet. Hence, each of the streams mixed and contained in a TS can be identified as a video stream or an audio stream and can, therefore, be played back as images or sound.

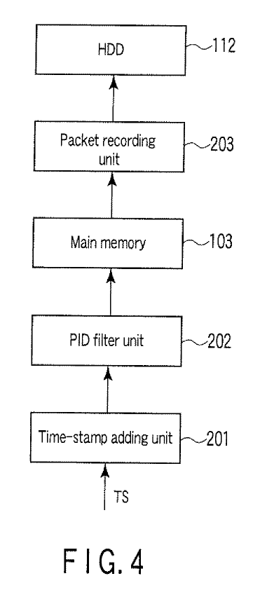

How data flows to record a transport stream will be explained, with reference to the flowchart of FIG. 4.

The main unit 11 of the computer 10 has a time-stamp adding unit 505, a PID filter unit 506, and a packet recording unit 203, as is illustrated in FIG. 4.

A TS packet received is supplied to the time-stamp adding unit 505. The time-stamp adding unit 505 adds a 4-byte time stamp to the head of the 188-byte TS packet, generating a 192-byte packet. The time stamp indicates the time order the TS packet has with respect to any other TS packet.

The PID filter unit 506 is a filter circuit that monitors the PIDs of TS packets and extracts only the TS packets indispensable to play back the program the viewers want to enjoy. More precisely, in accordance with the PIDs of the TS packets included in a descramble transport stream, the PID filter unit 506 extracts only the TS packets corresponding to the broadcast program data to be played back for the viewers, from the transport stream. The broadcast program to be played back is designated by the CPU 101. Any packet the PID filter unit 506 has extracted is sent to the main memory 103. The packet recording unit 203 records the TS packets stored in the main memory 103 in the HDD 111.

A configuration that records the transport stream, which has been thus stored in the HDD 111, in the HD DVD/DVD drive 112, will be described.

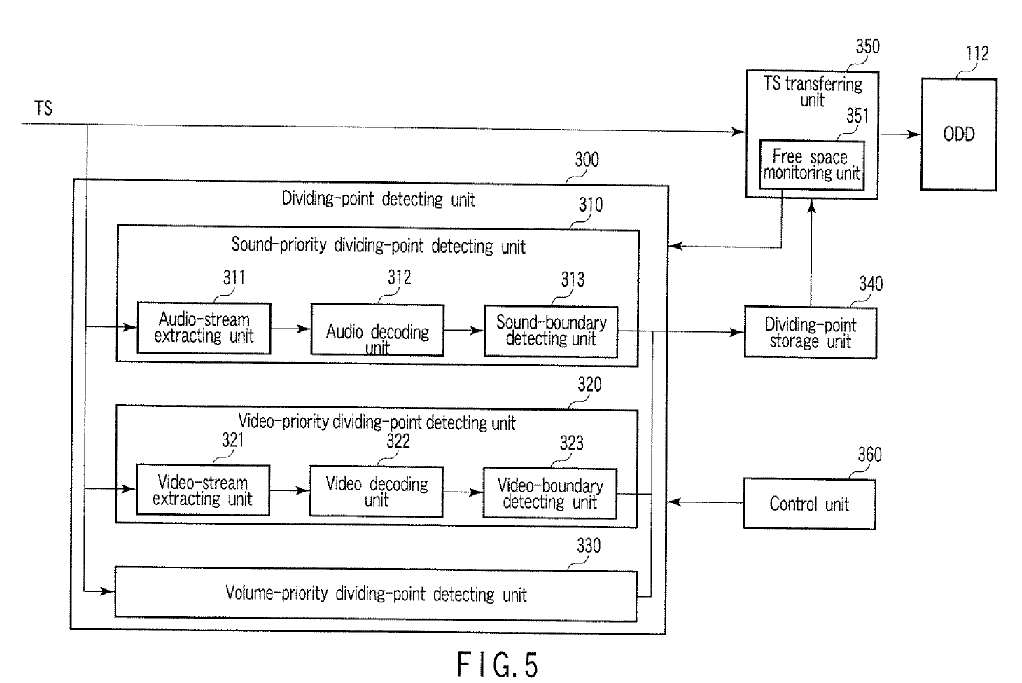

FIG. 5 is a block diagram showing this configuration provided in the apparatus according to the first embodiment and designed to record a transport stream stored in the HDD 111, in the HD DVD/DVD drive 112.

As FIG. 5 shows, the configuration has a dividing-point detecting unit 300, a dividing-point storage unit 340, a transport-stream (TS) transferring unit 350, and a control unit 360.

The dividing-point detecting unit 300 has an audio-priority dividing-point detecting unit 310, a video-priority dividing-point detecting unit 320, and a volume-priority dividing-point detecting unit 330.

The audio-priority dividing-point detecting unit 310 has an audio-stream extracting unit 311, an audio decoding unit 312, and a sound-boundary detecting unit 313.

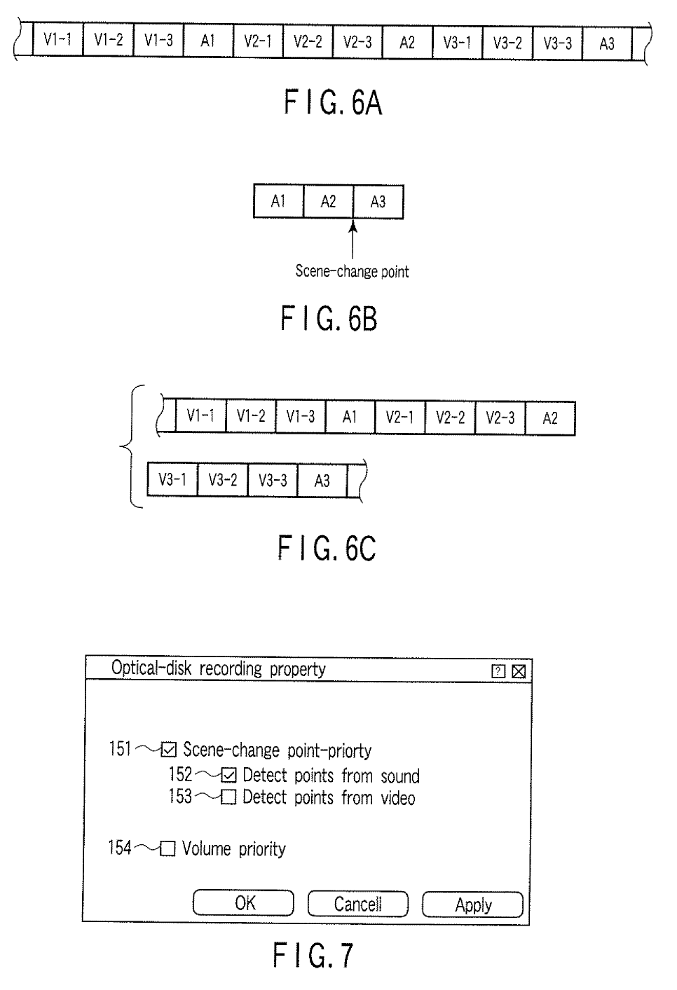

The audio-stream extracting unit 311 extracts an audio stream (FIG. 6B) from a transport stream (FIG. 6A) transferred from the transport-stream (TS) transferring unit 350 to the HD DVD/DVD drive 112. The audio decoding unit 312 decodes the extracted audio stream. The sound-boundary detecting unit 313 analyzes the audio data decoded, and also detects a scene-change point (FIG. 6B). Further, the sound-boundary detecting unit 313 stores the time stamp of the packet that contains the scene-change point (i.e., dividing point) in the dividing-point storage unit 340.

The sound-boundary detecting unit 313 designates, as a boundary point, the audio-output change point (i.e., scene-change point) detected from the analysis of the audio stream. The audio-output change point is a point where the audio mode is switched between monaural mode and stereophonic mode, or is switched between non-multiplex mode and multiplex mode (bilingual broadcasting).

Alternatively, the sound-boundary detecting unit 313 may detect a point (scene-change point) where the bit rate has greatly changed, from the analysis of the audio stream, and designates this point as the boundary point. Audio-video data, such as CM data, greatly changes in sound volume, in comparison with the audio-video data representing the TV program proper. Therefore, the CM can be distinguished from the TV program proper, from the point where the bit rate has greatly changed.

The sound-boundary detecting unit 313 may designate, as boundary points, the first and last (i.e., two scene-change points) of the anacoustic parts which have been detected from the analysis of the audio stream and which are regularly continuous to one another. CM programs, for example, last for a multiple of a predetermined period (e.g., 15 seconds) each. Therefore, a CM section that is a sequence of two or more CM programs lasts for a multiple of that predetermined period, too. An anacoustic part exists between the TV program proper and the CM program, and an anacoustic part exists between each CM program and the next CM program. In consideration of these, the first of the anacoustic parts that are regularly continuous to one another is a switching point, from the TV program proper to the CM section, whereas the last anacoustic part is a switching point, from the CM section to the TV program proper.

The video-priority dividing-point detecting unit 320 has a video-stream extracting unit 321, a video decoding unit 322, and an image-boundary detecting unit 323.

The video-stream extracting unit 321 extracts a video stream from a transport stream to transfer from the transferring unit 350 to the HD DVD/DVD drive 112. The video decoding unit 322 decodes the extracted video stream. The image-boundary detecting unit 323 analyzes the decoded video data, and also detects a scene-change point. Further, the video-boundary detecting unit 323 stores the time stamp of the packet that contains the scene-change point (i.e., dividing point) in the dividing-point storage unit 340.

The image-boundary detecting unit 323 analyzes an audio-video signal decoded by the video decoder and detects a boundary point existing in this audio-video signal. The image-boundary detecting unit 323, for example, detects a scene-change point from the analysis of the similarity between the frames included in the video data, and designates this scene-change point as a boundary point. That is, if similar frames follow one another, the unit 323 will determine that no scene-changes points exist; if different frames follow one another, the unit 323 will designate the junctions of these frames as scene-changes points.

Alternatively, the video-boundary detecting unit 323 may designate, as a dividing point, any scene-change point that has been detected from the analysis of the luminance signals for the frames that are contained in the video data.

The volume-priority dividing-point detecting unit 330 sets dividing points so that as many transport streams as possible may be recorded in one HD DVD-R disc.

The control unit 360 displays such a window as shown in FIG. 7. Using the window, the user selects the audio-priority dividing-point detecting unit 310, the video-priority dividing-point detecting unit 320 or the volume-priority dividing-point detecting unit 330, so that the dividing-point detecting unit selected may set dividing points. As FIG. 7 shows, the window has two check boxes, 151 and 154. If the user clicks the check box 151, the program will be divided at scene-change points. If the user clicks the check box 154, the program will be divided in accordance with the volume thereof. The check boxes 151 and 154 are exclusively selected. When the user selects the check box 151, two check boxes 152 and 153 become effective. If the check box 152 is selected, the sound will be analyzed to detect scene-change points. If the check box 153 is selected, the video will be analyzed to detect scene-change points.

The transport-stream (TS) transferring unit 350 transfers a transport stream to the HD DVD/DVD drive 112, so that the transport stream may be recorded in an HD DVD-R disc inserted in the HD DVD/DVD drive 112. The transport-stream (TS) transferring unit 350 performs control so that the packets following a time stamp, if stored in the dividing-point storage unit 340, may be first recorded in another HD DVD-R disc incorporated in the HD DVD/DVD drive 112 (see FIG. 6C).

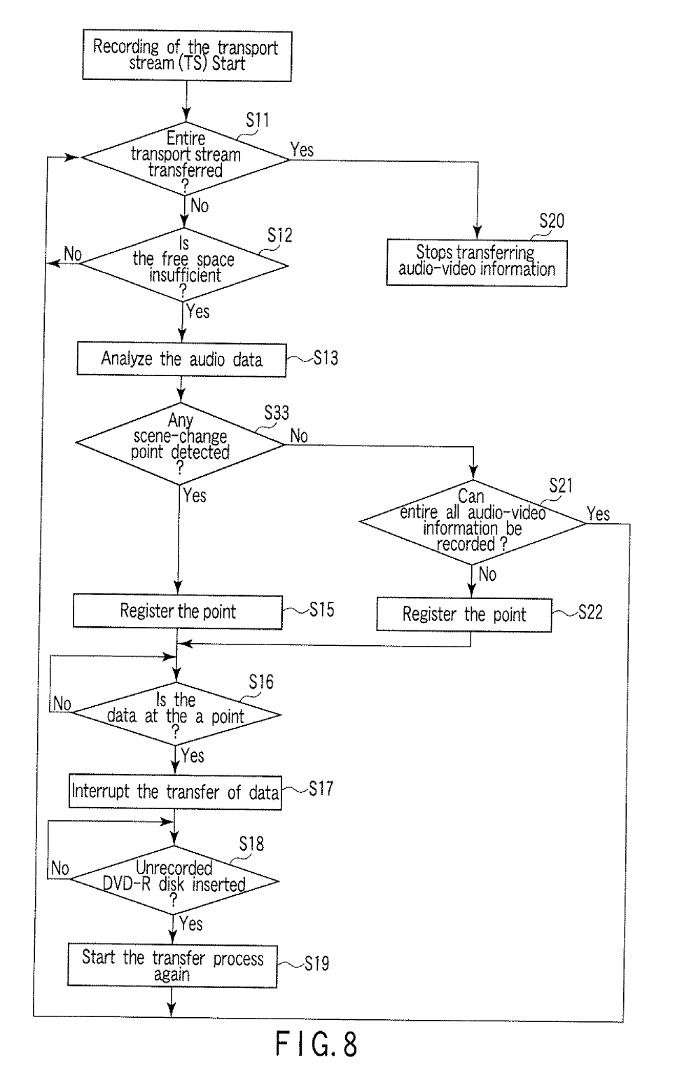

How the HD DVD/DVD drive 112 is used to record a transport stream stored in the HDD 111, in an HD DVD-R disc will be explained, with reference to the flowchart of FIG. 8.

The TS transferring unit 350 transfers a transport stream, starting with the first packet, while saving an amount of data which corresponds to the storage capacity of a buffer memory for saving data. As the TS transferring unit 350 thus transfers the transport stream in this way, the following process sequence is performed.

The TS transferring unit 350 determines whether the entire transport stream has been transferred (Step S11). If the entire transport stream has been transferred (if Yes in Step S11), the TS transferring unit 350 finishes transferring the transport stream (Step S20).

If the unit 350 does not determine that the entire transport stream has been transferred (if No in Step S11), the free space monitoring unit 351 incorporated in the TS transferring unit 350 determines whether the storage available in the HD DVD-R disc is insufficient (e.g., less than 0.5 Gbytes) (Step S12). If the storage available is not insufficient (if No in Step S12), the process returns to Step S11.

If the storage available is insufficient (if Yes in Step S12), the free space monitoring unit 351 instructs the dividing-point detecting unit 300 to detect dividing points. It will be explained how dividing points are detected if the user has selected the audio-priority dividing-point detecting unit 310.

The audio-priority dividing-point detecting unit 310 analyzes the audio-stream packet that constitutes the last part of the transport stream temporarily saved in the buffer memory (Step S13). The unit 310 then determines whether the audio-stream packet contains scene-change points (i.e., dividing points) (Step S14).

The audio-priority dividing-point detecting unit 310 may detect a dividing point in the packet analyzed. In this case (Yes in Step S14), the audio-priority dividing-point detecting unit 310 informs the TS transferring unit 350 that a dividing point has been detected in the packet. The unit 310 then stores the time stamp of the packet at the dividing point (P), in the dividing-point storage unit 340 (Step S15).

From the dividing-point storage unit 340, the TS transferring unit 350 acquires the time stamp of the packet at the dividing point. The TS transferring unit 350 monitors the time stamps of the packet s, while transferring the transport stream to the HD DVD/DVD drive 112 (Step S16). When the time stamp of the next packet to be transferred to the HD DVD/DVD drive 112 becomes a time stamp for a dividing point, the TS transferring unit 350 temporarily stops transferring the transport stream (Step S17).

Then, the TS transferring unit 350 prompts the user to insert a new, unrecorded HD DVD-R disc into the HD DVD/DVD drive 112 and determines whether an HD DVD-R disc has been inserted into the HD DVD/DVD drive 112 (Step S18). If the TS transferring unit 350 determines that an HD DVD-R disc has been inserted into the drive 112 (Yes in Step S18), it will resume the transfer of the transport stream (Step S19).

The TS transferring unit 350 need not be informed that the dividing points have been detected (No in Step S14). If this is the case, the free space monitoring unit 351 determines whether the transport stream already analyzed and held in the buffer memory can be recorded in the HD DVD-R disc (Step S21). If the unit 315 determines that the transport stream can be recorded (if Yes in Step S21), the TS transferring unit 350 will keep transferring the data.

The free space monitoring unit 351 may not determines that the transport stream can be recorded (No in Step S21), it will instruct the audio-priority dividing-point detecting unit 310 to stop detecting dividing points and instructs the volume-priority dividing-point detecting unit 330 to set dividing points.

The volume-priority dividing-point detecting unit 330 detects dividing points so that as many transport streams as possible may be recorded in one HD DVD-R disc. After detecting dividing points, the unit 330 informs the TS transferring unit 350 that the dividing points have been detected. The unit 330 then stores the time stamp of the packet at each dividing point in the dividing-point storage unit 340 (Step S22).

The TS transferring unit 350 acquires the time stamp of the packet at each dividing point. The TS transferring unit 350 monitors the time stamp of the packet, while transferring the transport stream to the HD DVD/DVD drive 112 (Step S16). When the time stamp of the next packet to be transferred to the HD DVD/DVD drive 112 becomes a time stamp for a dividing point, the TS transferring unit 350 stops transferring the transport stream (Step S17).

The TS transferring unit 350 prompts the user to insert an HD DVD-R disc into the HD DVD/DVD drive 112 and determines whether an HD DVD-R disc has been inserted into the HD DVD/DVD drive 112 (Step S18). If the TS transferring unit 350 determines that an HD DVD-R disc has been inserted into the drive 112 (Yes in Step S18), it will resume the transfer of the transport stream (Step S19).

If the transport stream cannot be recorded in one HD DVD-R disc, the transport stream can be recorded in a plurality of HD DVD-R discs, such that all adjacent parts bordering scene-change points in the content of the transport stream are stored in two HD DVD-R discs, respectively. As a result, both the video data and the audio data can be smoothly played back at the start of playing back the transport stream.

### Second Embodiment

A method of trans-coding a transport stream, thereby writing the stream in a DVD-R disc, will be explained. This is a method suitable for recording data in DVD-based discs, such as DVD-R discs, at as high a rate as possible so that the data may represent high-quality images.

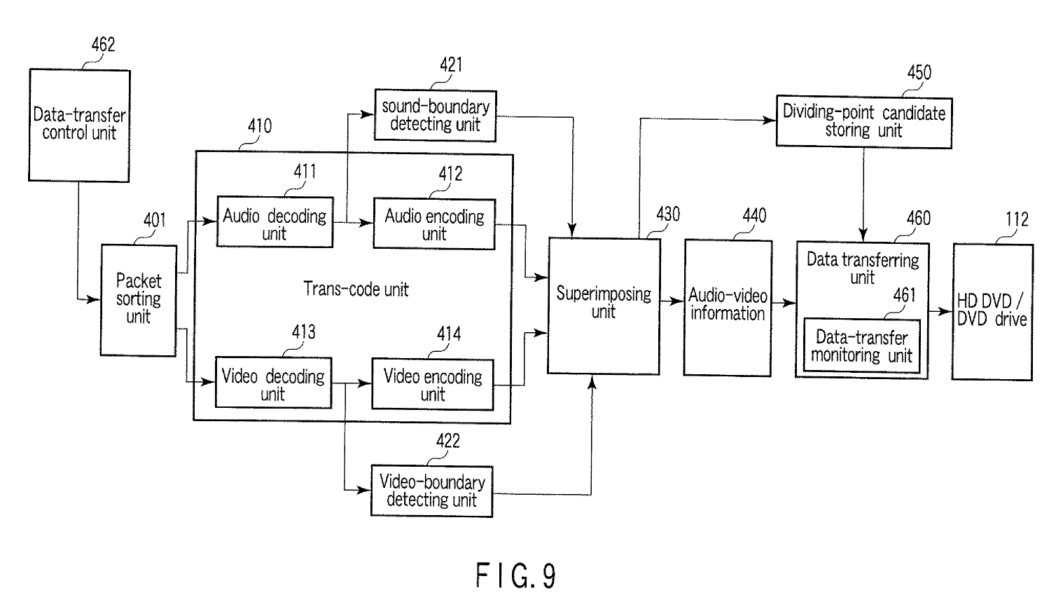

An apparatus for trans-coding the content of a transport stream, thereby generating audio-video information, and then storing the audio-video information in a DVD-R disc will be described, with reference to FIG. 9.

As FIG. 9 shows, this apparatus for recording video-audio data has a packet sorting unit 401, a trans-code unit 410, a sound-boundary detecting unit 421, an image-boundary detecting unit 422, a superimposing unit 430, a dividing-point candidate storing unit 450, a data transferring unit 460, and an HD DVD/DVD drive 112.

The packet sorting unit 401 extracts the audio-stream packet and video-stream packet from a transport stream and supplies these packets to the trans-code unit 410.

The trans-code unit 410 has an audio decoding unit 411, an audio encoding unit 412, and a video decoding unit 413, and a video encoding unit 414.

The audio decoding unit 411 decodes a compressed audio stream, generating audio data. The audio encoding unit 412 encodes the audio data thus generated.

The video decoding unit 413 decodes a compressed video stream, generating video data. The video encoding unit 414 encodes the video data thus generated.

The superimposing unit 430 superimposes the audio data and the video data, each having been re-encoded, one with the other, thus generating audio-video information 440 of a program-stream type. The audio-video information 440 is constituted by packs, each consisting of packetized elementary streams (PES) packets, each of which is either a video stream or an audio stream. Each pack has a pack header. In the pack header, a pack-start coder reference-time information and a multiplexing bit rate (mux_rate) are described, in the order they are mentioned. The reference-time information is known as system clock reference (SCR).

The sound-boundary detecting unit 421 analyzes the audio data decoded, thereby detecting scene-change points in the same way as in the first embodiment. After detecting the scene-change points, the sound-boundary detecting unit 421 supplies the time stamps of the scene-change points (i.e., dividing-points candidates) to the superimposing unit 430.

The video-boundary detecting unit 422 analyzes the video data decoded, thereby detecting scene-change points in the same way as in the first embodiment. After detecting the scene-change points, the video-boundary detecting unit 422 supplies the time stamps of the scene-change points (i.e., dividing-points candidates) to the superimposing unit 430.

Note that scene-change points are detected by either the sound-boundary detecting unit 421 or the image-boundary detecting unit 422. That is, the user designates, as a scene-change point detecting unit, the sound-boundary detecting unit 421 or the image-boundary detecting unit 422. Hence, the apparatus of FIG. 9 need only have one boundary detecting unit, the unit 421 or 422.

The superimposing unit 430 generates an SCR from the time stamps of the transport stream. More precisely, the superimposing unit 430 receives the time stamps of the dividing-point candidates from the sound-boundary detecting unit 421 or image-boundary detecting unit 422 and generates SCR information from the time stamps. The SCR information is stored in the dividing-point candidate storing unit 450.

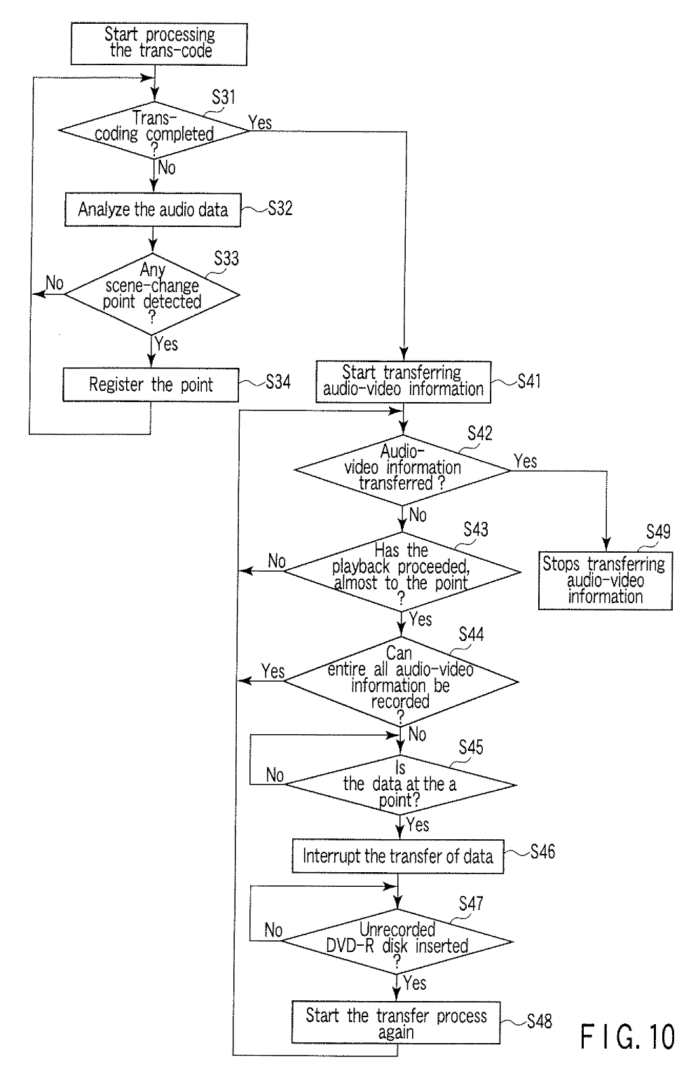

The sequence of processing and storing the trans-code will be explained with reference to the flowchart of FIG. 10. The following explanation is based on the assumption that the sound-boundary detecting unit 421 is used to detect scene-change points (i.e., dividing-point candidates).

First, the trans-code unit 410 starts trans-coding the transport stream. Then, it is determined whether the trans-coding has completed (Step S31). If No, the sound-boundary detecting unit 421 analyzes the audio data (Step S32). Next, it is determined whether the unit 421 has detected a scene-change point (Step S33). If the sound-boundary detecting unit 421 has detected a scene-change point (i.e., dividing point candidate) (if Yes in Step S33), the sound-boundary detecting unit 421 supplies the time stamp of the scene-change point to the superimposing unit 430. The superimposing unit 430 registers the data-transfer monitoring unit 461 corresponding to the time stamp in the dividing-point candidate storing unit 450 (Step S34). Steps S31 to S34 are repeated until the trans-code unit 410 finishes trans-coding the transport stream.

When the unit 410 finishes trans-coding the transport stream (Yes in Step S31), the data transferring unit 460 starts transferring audio-video information 440 to the HD DVD/DVD drive 112 so that the data 440 may be recorded in the DVD-R disc (Step S41). As FIG. 9 shows, the data transferring unit 460 has a data-transfer monitoring unit 461 and a data-transfer control unit 462. The data-transfer control unit 462 determines whether all the audio-video information 440 has been transferred to the HD DVD/DVD drive 112 (Step S42). If all the data 440 has been transferred (if Yes in Step S42), the data-transfer control unit 462 stops operating (Step S49).

The data-transfer monitoring unit 461 extracts the SCR from the pack being transferred. The unit 461 then compares the SCR with the SCR of the dividing point candidate to transfer next, determining whether the playback has proceeded almost to the dividing point candidate (Step S43).

If the playback has proceeded almost to the dividing point candidate (if Yes in Step S43), the data-transfer monitoring unit 461 informs the data-transfer control unit 462 of this event. Then, the data-transfer control unit 462 compares the free space available in the DVD-R disc when the playback proceeds almost to the dividing point candidate with the size of that part of the audio-video information which exists between the dividing point candidate and the next dividing point candidate. Thus, the data-transfer control unit 462 determines whether the audio-video information can be recorded in the DVD-R disc, up to the next dividing point candidate (Step S44).

If it is determined that all the audio-video information can be recorded (if Yes in Step S44), the data transferring unit 460 keeps transferring the audio-video information to the HD DVD/DVD drive 112. In this case, all the audio-video information is recorded in the DVD-R disc.

If it is determined that the entire audio video information cannot be recorded (if No in Step S44), the data-transfer control unit 462 causes the data-transfer monitoring unit 461 to determine whether the data about to be transferred is at the dividing point candidate (Step S45).

If this data is at the dividing point candidate (if Yes in Step S45), the data-transfer monitoring unit 461 informs the data-transfer control unit 462 of this event. So informed, the data-transfer control unit 462 temporarily stops transferring the data (Step S46).

The data-transfer control unit 462 prompts the user to insert a new, unrecorded DVD-R disc into the HD DVD/DVD drive 112. The unit 462 then determines whether the user has inserted an unrecorded DVD-R disc into the HD DVD/DVD drive 112 (Step S47). If it is determined that an unrecorded DVD-R disc has been inserted into the HD DVD/DVD drive 112 (if Yes in Step S47), the data-transfer control unit 462 resumes the transfer of the transport stream.

As indicated above, if the audio-video information trans-coded cannot be recorded in one DVD-R disc, it can be divided into parts at a scene-change point of the content analyzed during the trans-coding, whereby the audio-video information can be recorded partly in one DVD-R disc and partly in another DVD-R disc. As a result, both the image and sound represented by the audio-video information can be smoothly played back from the DVD-R discs.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An apparatus for recording audio-video information comprising:
a storage device configure to store audio-video information containing video data and audio data;
an optical disc drive configured to record the audio-video information in a recoding-type optical disc;
detecting section configure to detect a free space available in the recoding-type optical disc, when the audio-video information is being recorded in the recoding-type optical disc; and
analysis-type divided-recording control section configure to analyze the content of the audio-video information when the detected free space is smaller than a preset value, thereby detecting dividing points, to divide the audio-video information into parts in accordance with the detected dividing points, and to control recording the parts of the audio-video information in the recoding-type optical disc and at least one other recoding-type optical disc.

2. The apparatus according to claim 1, wherein the analysis-type divided-recording control section comprises dividing section configure to designate, as the dividing points, scene-change points detected in accordance with a result of analysis of audio data included in the audio-video information.

3. The apparatus according to claim 1, wherein the analysis-type divided-recording control section comprises dividing section configure to designate, as the dividing points, scene-change points detected in accordance with a result of analysis of video data included in the audio-video information.

4. The apparatus according to claim 1, further comprising:
volume-priority divided-recording control means for setting dividing points in accordance with the free space available in the recoding-type optical disc when the free space detected by the detecting section is smaller than another preset value, thereby dividing the audio-video information into parts, and For controlling recording the parts of the audio-video information in the recoding-type optical disc and at least one other recoding-type optical disc; and
selecting section configure to enable a user to select the analysis-type, divided-recording control section or the volume-priority divided-recording control section when one recoding-type optical disc is unable to store the audio-video information, thereby to record the audio-video information in a plurality of recoding-type optical discs.

5. The apparatus according to claim 4, wherein the analysis-type divided-recording control section comprises sound-priority dividing-point detecting section configure to designate, as the dividing points, detected scene-change points in accordance with a result of analysis of audio data included in the audio-video information, and an video-priority dividing-point detecting section configure to designate, as the dividing points, scene-change points detected in accordance with a result of analysis of video data included in the audio-video information, and in which the selecting section prompts the user to select the sound-priority dividing-point detecting section or the video-priority dividing-point detecting section when the analysis-type divided-recording control section is selected, thereby to record the audio-video information in a plurality of recoding-type optical discs.

6. An apparatus for recording audio-video information comprising:
a storage device configure to store first audio-video information containing video data and audio data;
conversing section configure to convert the first audio-video information to second audio-video information;
an optical disc drive configured to record the second audio-video information in a recoding-type optical disc;
dividing-point detecting section configure to analyze the content of the first audio-video information while the first audio-video information is being converted, thereby detecting dividing points existing in the second video-audio information;
detecting section which detect a free space in the recoding-type optical disc, while the second audio-video information is being recorded in the optical disc drive; and
control section configure to control the recording of the second audio-video information, in accordance with the detected free space, thereby to divide the second audio-video information into parts at the dividing points and to record the parts of the second audio-video information in the recoding-type optical disc and at least one other recoding-type optical disc.

7. The apparatus according to claim 6, wherein the control section comprises dividing section configure to designate, as the dividing points, scene-change points detected in accordance with a result of analysis of audio data included in the audio-video information.

8. The apparatus according to claim 6, wherein the control section comprises dividing section configure to designate, as the dividing points, scene-change points detected in accordance with a result of analysis of video data included in the audio-video information.

9. A method of recording digital audio-video information in an apparatus for recording audio-video information in recoding-type optical discs, which comprises a storage device for storing audio-video information containing video data and audio data and an optical disc drive for writing the audio-video information in the recording-type optical discs, the method comprising:
detecting a free space available in a recoding-type optical disc, while the audio-video information is being recorded in the recoding-type optical disc; and
analyzing the content of the audio-video information when the detected free space is smaller than a preset value, thereby detecting dividing points, for dividing the audio-video information into parts in accordance with the dividing points detected, and for controlling the optical disc drive, thereby recording the parts of the audio-video information in a plurality of recoding-type optical discs.

10. The method according to claim 9, wherein the dividing points are scene-change points detected in accordance with a result of analysis of audio data included in the audio-video information.

11. The method according to claim 9, wherein the dividing points are scene-change points detected in accordance with a result of analysis of video data included in the audio-video information.

12. A method of recording digital audio-video information in an apparatus for recording audio-video information in recoding-type optical discs, which comprises a storage device for storing first audio video information containing video data and audio data, conversing means for converting the first audio-video information to second audio-video information, and an optical disc drive for writing second audio-video information in the recording-type optical discs, the method comprising:
analyzing the content of the first audio-video information white the first audio-video information is being converted, thereby detecting dividing points existing in the second video-audio information;
detecting a free space available in the recoding-type optical disc, while the second audio-video information is being recorded in an optical disc drive; and
controlling the recording of the second audio video information, in accordance with the detected free space, thereby to divide the second audio-video information into parts at the dividing points and to record the parts of the second audio-video information in a plurality of recoding-type optical discs.

13. The method according to claim 12, wherein the dividing points are scene-change points detected in accordance with a result of analysis of audio data included in the audio-video information.

14. The method according to claim 12, wherein the dividing points are scene-change points detected in accordance with a result of analysis of video data included in the audio-video information.
